(19) United States
(12) Patent Application Publication
(10) Pub. No.: US 2024/0012646 A1
(43) Pub. Date: Jan. 11, 2024

(54) SYSTEM AND METHOD OF PREFETCHING ARRAY SEGMENTS

(71) Applicant: HUAWEI TECHNOLOGIES CO., LTD., SHENZHEN (CN)

(72) Inventors: Tomasz Sebastian CZAJKOWSKI, Etobicoke (CA); Reza AZIMI, Aurora (CA); Maziar GOUDARZI, Toronto (CA); Man Pok HO, Markham (CA); Julian HUMECKI, Etobicoke (CA)

(73) Assignee: HUAWEI TECHNOLOGIES CO., LTD., SHENZHEN (CN)

(21) Appl. No.: 17/858,175

(22) Filed: Jul. 6, 2022

(51) Int. Cl. G06F 9/30; G06F 12/0862; G06F 9/54

(52) U.S. Cl. CPC G06F 9/30047; G06F 12/0862; G06F 9/30043; G06F 9/541

(57) ABSTRACT

There is provided a system and method of prefetching array segments. A prefetcher management unit (PMU) is disclosed. The PMU includes an interface to interact with programs via an application programming interface (API) and one or more data structures configured to store a plurality of addresses, each of the plurality of addresses representing a memory location of data stored in an array segment. The PMU also includes a prefetcher interface configured to use an address in the one or more data structures to instruct a prefetcher to prefetch data into a cache and a load-store unit interface configured to use the address in the one or more data structures to instruct a load-store unit to load data from the cache.

### CROSS-REFERENCE TO RELATED APPLICATIONS

This is the first application filed for the present disclosure.

### FIELD

The present disclosure relates to the field of high-performance computing and particularly to systems and methods for providing efficient prefetching of array segments.

### BACKGROUND

Arrays, including hash tables, may offer a convenient and effective data structure to store data used by a computer program. One drawback of these kinds of data structures is that locality of access may become a problem, in that subsequent accesses to the data structure can require access to memory locations which are not available in the processor's cache. As a result, the algorithm may be efficient from a complexity standpoint, but the underlying data structure may cause the processor to stall waiting for data, thus reducing performance of a program using the data structure.

Processors can operate prefetching units to address the problem of stalling and waiting for data from memory. In anticipation of a data access request, a prefetching unit can ask for the required data before the actual data access instruction is executed. This allows an overlap in program execution with data retrieval, thereby hiding the memory access latency and increasing performance of a program. Prefetching units may be configured to look for specific patterns of data access, such as sequential access, to determine which memory locations to prefetch. However, accesses to data stored in structures such as hash tables may be essentially random, preventing a prefetching unit from operating effectively with data stored in these structures.

Therefore, there is a need for a system and method which can improve access to data stored in an array structure, such as a hash table.

This background information is provided to reveal information believed by the applicant to be of possible relevance to the present disclosure. No admission is necessarily intended, nor should be construed, that any of the preceding information constitutes prior art against the present invention.

### SUMMARY

The present disclosure provides systems and methods to promote the use of hashes for their algorithmic complexity benefits while mitigating the impact they have on cache miss rates to attain improved performance. The system includes a prefetcher management unit (PMU) which is configured to store hash access addresses, a prefetcher configured to prefetch data into cache memory using the stored hash access address, and a load-store unit configured to load data from cache memory using the stored hash access address. The methods can also convert ordinary code into a compiled binary which uses an application programming interface (API) to leverage the features of the PMU to reduce cache miss rates and improve performance.

In one aspect of the present disclosure, there is provided a method of prefetching array segments with pseudo-random access patterns. The method includes storing one or more addresses in a data structure, wherein each of the one or more addresses representing a memory location of data stored in an array segment. The method further includes prefetching data to a cache line using an address of the one or more addresses and driving input to a load-store unit (LSU) to load the prefetched data from the cache line using the address of the one or more addresses.

In some embodiments, storing one or more addresses includes storing one or more hash access addresses. In some embodiments, storing one or more addresses includes storing one or more hash offset addresses which can be added to a base memory location to form a hash access address.

In some embodiments, prefetching data to a cache line using an address of the one or more addresses includes instructing a prefetcher interface to use a prefetcher to prefetch data to a cache line using an address of the one or more addresses. In some embodiments, prefetching data to a cache line using an address of the one or more addresses includes prefetching data to be used in a loop prior to its use in the loop and driving input to a LSU to load the prefetched data includes driving input to the LSU to load the prefetched data when the prefetched data is used in the loop.

In some embodiments, storing one or more addresses in a data structure includes storing a plurality of addresses in a first-in-first-out (FIFO) data structure.

In some embodiments, the method further includes releasing the data structure.

In another aspect of the present disclosure, there is provided a prefetcher management unit (PMU). The PMU includes an interface to interact with programs via an application programming interface (API) and one or more data structures configured to store a plurality of addresses, each of the plurality of addresses representing a memory location of data stored in an array segment. The PMU further includes a prefetcher interface configured to use an address in the one or more data structures to instruct a prefetcher to prefetch data into a cache and a load-store unit interface configured to use the address in the one or more data structures to instruct a load-store unit to load data from the cache.

In some embodiments, the PMU further includes a control interface which is configured to return a handle associated with a function, configured to interact with programs via an API and a data interface which is configured to receive the handle and to cache and retrieve data stored in array segments associated with the function, configured to interact with programs via an API.

In some embodiments, the one or more data structures comprise one or more FIFO data structures. In some embodiments, the plurality of addresses includes a plurality of hash access addresses. In some embodiments, each address of the plurality of addresses includes a hash offset address which can be added to a base memory address to form a hash access address.

In another aspect of the present disclosure, there is provided a method of compiling source code including a hash optimization pass. The method includes receiving source code and identifying portions of the source code which can be accelerated using a prefetcher management unit (PMU). The method further includes inserting calls to a PMU in the source code and compiling the source code to generate a binary.

In some embodiments, identifying portions of the source code which can be accelerated using a PMU includes identifying portions of the source code which include accesses of data stored in an array segment in a loop. In some embodiments, identifying portions of the source code which can be accelerated using a PMU includes identifying portions of the source code which include hash accesses in a loop.

In some embodiments, inserting calls to a PMU in the source code includes associating an array with a first-in-first-out (FIFO) using a prefetcher application programming interface (API) and determining a prefetching distance and creating a precompute loop. Inserting calls to a PMU in the source code further includes inserting instructions into the source code to advance the FIFO and inserting instructions into the source code to release the FIFO.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 is an illustration of a hash table which maps keys to values.

FIG. 2 is an illustration of a compiler and a prefetcher management unit (PMU), according to one aspect of the present disclosure.

FIG. 3 is an illustration of a compiler and a PMU, according to one aspect of the present disclosure.

FIG. 4 is a flow chart which illustrates how a compiler can perform code transformations to leverage hash prefetching hardware and application programming interface (API), according to one aspect of the present disclosure.

It will be noted that throughout the appended drawings, like features are identified by like reference numerals.

### DETAILED DESCRIPTION

The present disclosure is generally directed towards improving the operation of cache memory when used with array segments with pseudo-random-access patterns. These types of data structures, including hash tables, may create locality of access problems as they may access memory locations in a pseudo-random pattern. These access patterns can reduce the effectiveness of cache prefetches, which may be based on fetching data sequentially. Thus, while there data structures may be efficient in some ways, they can increase data access times due to reducing the effectiveness of prefetching, leading to performance bottlenecks during cache misses.

A more efficient prefetching system may be used for these types of data structures. The system described herein is described using the example of hash functions, but this is merely exemplary and the algorithm may be used with any data structure whose underlying implementation is array-based. As an example, a data structure can be a linked list that is implemented such that all elements are stored in an array, wherein back and forth links are defined as indices to the array. The system may include precomputing hash keys for operations which are in loops. The system may then use the precomputed hash and hash array pointer to compute the address, and have a prefetcher load the corresponding cache lines. The prefetcher may then pass on the addresses it received to specific load instructions to retrieve the data. This system only requires computing a data address a single time, offering improved efficiency. The system works to compute prefetch addresses, rather than merely predicting the addresses, which can improve accuracy. The system may allow addresses to be prefetched long ahead of code execution.

The system may be implemented using a combined hardware and software solution, and can significantly improve hash usage inefficiency. A hardware feature may include the necessary logic to prefetch hash entries ahead of time and facilitate storage for related load operations. Meanwhile, a compiler (software) may be responsible for identifying when the hardware feature will benefit compiler runtime and may generate code that directly uses the new hardware feature.

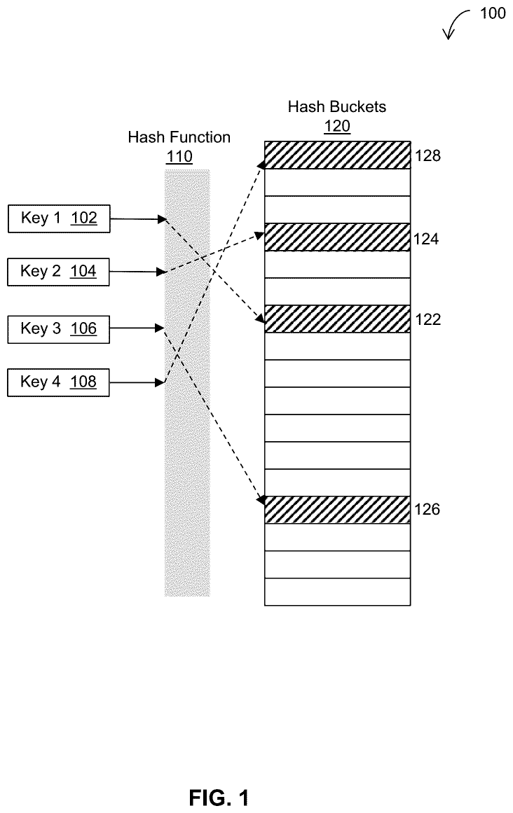

FIG. 1 is an illustration of a hash table 100 which maps keys to values. Generally, the hash table 100 includes one or more keys 102, 104, 106, 108 and a hash function 110 which maps each of the one or more keys 102, 104, 106, 108 into a hash bucket 122, 124, 126, 128. For example, the hash table takes a key, such as a first key 102, as an input value and will output a hash bucket 120, such as bucket 122.

Hash tables can be a convenient and effective way to access data in a computer program. However, these data structures may not work efficiently with cache memory, which can create performance bottlenecks.

Generally, cache prefetching is used by computer processors to boost execution performance by fetching instructions or data from their original storage in slower memory to a faster local memory before it is needed by an application. This prefetched data can be stored in a cache memory, which may be accessed much more quickly than the memory in which the instructions or data were originally stored, thereby improving performance of a device by reducing delay caused by memory access. Processors may be configured to prefetch data in a sequential manner to improve data access times by reducing delays in obtaining data from slower memory.

However, cache prefetching may not be effective when used with data structures which have pseudo-random access patterns, such as hash tables. For example, a program may use each of four hash keys 102, 104, 106, 108, each of which is associated with a hack bucket 122, 124, 126, 128. However, these hash buckets 122, 124, 126, 128 may not be sequential in the memory and may instead have a roughly random-access pattern within the memory. This non-sequential access pattern can increase cache miss rate, where the needed data is not stored in a processor's cache and must be retrieved from its original storage in slower memory. Accordingly, while hashes (maps) can be used to reduce algorithmic complexity in high-performance and database programs, these data structures may create performance trade-offs by reducing cache locality. This can lead to sub-optimal performance when using hashes on modern processors.

Hash functions are merely one example of a data structure which includes array segments with a pseudo-random access pattern. Each of these data structures may lead to increased cache misses, thereby slowing the operation of a processor by requiring the system to wait for data retrieval from slower memory. Accordingly, it may be beneficial to use a prefetcher management unit (PMU) for hash tables and also for other data structures with similar characteristics, where the PMU is configured to improve prefetcher performance and decrease cache misses. For simplicity, examples herein use hash functions to demonstrate this functionality, but it should be understood that these approaches are equally applicable to other data structures.

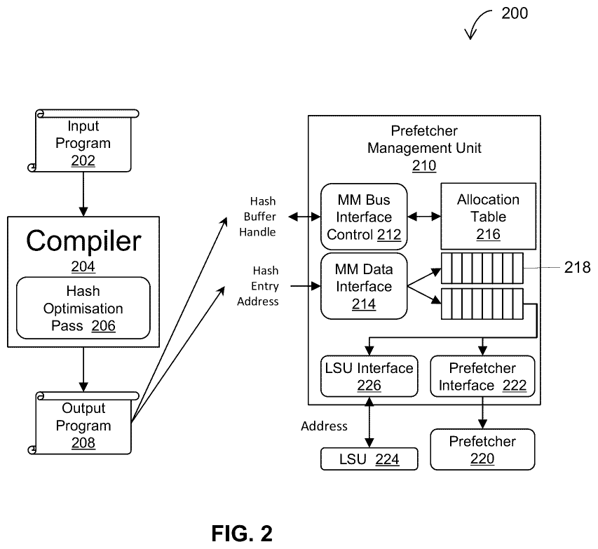

FIG. 2 is an illustration 200 of a compiler 204 and a prefetcher management unit 210, according to one aspect of the present disclosure.

An input program 202 may be compiled by a compiler 204. The input program 202 may be written in any language, and a suitable compiler 204 may be selected. The compiler 204 may be configured to take the input program 202 and produce output program 208, which is a compiled binary that can run on a processor. The compiler 204 may include a hash optimization pass 206. The hash optimization pass 206 may be configured to detect scenarios in the input program 202 which can profitably use the prefetcher management unit 210 to improve the performance of the output program 208.

When it detects and appropriate scenario, the hash optimization pass 206 may put hooks into the code to use a control interface 212 and a data interface 214 in the prefetcher management unit 210. The control interface 212 may be configured to receive commands from the output program 208. These commands describe a location of a hash in memory, and the control interface 212 returns a handle (if available) that the output program 208 can use to reference the allocated prefetcher management unit 210 resources. The control interface 212 may include an allocation table 216, which stores the address in memory where a given hash table begins.

Once the output program 208 receives a handle from the control interface 212, the program can use the data interface 214 to deposit hash access addresses for prefetching in a first-in-first-out (FIFO) 218 data structure, and then pull the addresses from the FIFO 218 by executing a read, thereby keeping the program 206 synchronized with the hash prefetching facility. Each handle returned by the control interface 212 may be assigned its own FIFO 218. The bus interface 212 may be configured to ensure that each client or handle is associated with a different FIFO 218. An arbiter may be used to ensure that only one request is processed at a time. For example, if a request on one bus takes the last FIFO slot, a subsequent request from any bus may fail to acquire a FIFO slot.

The FIFO 218 may be used to store hash access addresses, which can be used with a hash function to return data. The prefetcher management unit 210 further includes a prefetcher interface 222, which works with a prefetcher 220 to prefetch data which will be used by the output program 208. The prefetcher interface 222 may be configured to send the requested prefetch address to the prefetcher 220 to operate on. For example, the prefetcher 220 may be used to return data associated with the hash access addresses stored in the FIFO 218, and to store this data in cache memory for rapid access when needed by the processor.

The prefetcher management unit 210 further includes a load-store unit (LSU) interface 226, which works with a load-store unit 224. The LSU interface 226 may be used to send a given address to the LSU 224 to perform load on. This avoids the need to recompute load addresses in a source program. The request to retrieve a next address for a specific hash may come from the LSU 224 itself that, instead of calculating an address to load, obtains a handle from the FIFO 218 to use for next address.

Although prefetcher management unit 210 may be more effective when implemented in hardware, its operation may be illustrated in software. For example, a first program may include a loop:

```
For (i=0; i<N; i++) {
  hash_value = hash_function(A[i]);
  data = hash[hash_value];
  process(data);
}
```

The first program accesses a hash table, using a hash function that takes as input data from array A. However, without knowing what the data in A is, it may not be possible to predict an address in the hash that would be accessed. The first program then does some processing based on the retrieved data. However, an issue with the first program is that the hash access (data=hash[hash_value]) may take a long time, as it may not be possible for a conventional prefetcher to prefetch this data into memory. Accordingly, due to cache misses, this hash access may become a performance bottleneck for the first program.

This program may be transformed into a second program, which is more complex but more efficient, according to an aspect of the present disclosure:

```
#define PF_LD(X) _{——}builtin_prefetch((void*)(X), 0, 3)
#define PFD 4
Indirect_FIFO = malloc(sizeof(int*) * PFD);
For (i=0; i < PFD; i++) {
  Indirect_FIFO[i] = hash_function(A[i]);
  PF_LD(hash[Indirect_FIFO[i]);
}
For (i=0; i<N; i++) {
  // Access hash
  data = hash[Indirect_FIFO[i % PFD]];
  // Set up circular buffer for prefetcher to get
  // look ahead for subsequent accesses.
  if (i < N-PFD) {
    next_hash = hash_function(A[i+PFD]);
    Indirect_FIFO[i % PFD] = next_hash;
    PF_LD(hash[next_hash]);
  }
  // Perform data processing.
  process(data);
}
free(Indirect_FIFO);
```

The second program seeks to cure the deficiencies of the first program and may operate more quickly despite its length. The second program allocates a FIFO data structure (Indirect_FIFO) to store hash accesses that it wishes to prefetch. It also specifies a prefetching distance (PFD), which causes the required cache line to be prefetched that number of iterations ahead of the actual use of the data. In the second program, the prefetching distance is defined as 4, such that the program may prefetch data four loop iterations ahead of the operation of the program, keeping those results in cache.

Once the FIFO is allocated, the program enters a loop in which the first PFD number of entries in the FIFO are computed and prefetched using a PF_LD macro. These are the first PFD number of hash accesses which the program will access. For example, the Indirect_FIFO, when used with the hash table of illustration 100, may include “Key 1” 102, “Key 2” 104, “Key 3” 106, and “Key 4” 108, while the PF_LD macro ensures that the data from the associated hash buckets 122, 124, 126, 128 are loaded into the cache.

The program then enters the main for loop, during which both data processing and hash address computations for subsequent iterations occur. In the processing loop, the program first reads the data from the hash. Notably, the program no longer needs to compute the hash access (A[i]), but instead loading it from the corresponding location in the Indirect_FIFO. The main for loop then proceeds to compute the hash address for a future iteration of the loop, which is the prefetching distance of iterations ahead of the current portion of the loop, and place this hash address in the Indirect_FIFO and issue the prefetch command to load the data into cache. The loop then proceeds to process the data which is retrieved from the hash.

The second program may execute more quickly than the first program, despite its added length. This may be possible because prefetching data happens several iterations ahead of the need for the data, which allows the memory system the necessary time to load the data from slower memory into faster cache memory, while the main loop asynchronously proceeds to process data which is already available in the cache memory. This overlap of computation with data retrieval can provide performance benefits, as the second program may spend less time waiting for memory access due to cache misses than the first program. Finally, the second program frees the memory allocated for the FIFO, after the loop has completed.

The software-only approach of the second program has shortcomings, as the memory allocation and management of the FIFO takes some time the processor could have spent on other computation instead. Accordingly, it may be beneficial to move FIFO management and associated functionality to a hardware PMU, such as prefetcher management unit 210. The prefetcher management unit may then be accessible via an application programming interface (API), which in turn is based on an instruction set architecture (ISA) extension to enable this functionality.

A prefetcher management unit, such as such as prefetcher management unit 210, can include an API which allows programs to use the PMU. An exemplary PMU may include four methods: h_GetFIFO, h_PushFIFO, h_FIFOLoad, and h_ReleaseFIFO. Generally, the h_GetFIFO may be used to initialize a FIFO, the h_PushFIFO may be used to add an address to the FIFO and pre-fetch data associated with the address, h_FIFOLoad may be used to retrieve data and optionally to advance the FIFO, and h_ReleaseFIFO may be used to release the FIFO for use by other programs.

The h_GetFIFO method may be used to accesses a control interface to request an allocation of a FIFO for a specific hash table. If the PMU has a FIFO spot available, then the h_GetFIFO method may return a handle to the caller. For example, the h_GetFIFO method may set a base pointer for an associated FIFO array and may return a handle to the caller. This handle may, in turn, be used by each of the other API methods to ensure that they consistently refer to the same FIFO. The h_GetFIFO method can also include an attribute field to enable the PMU to behave differently depending on what is required by an application, including setting of a prefetch distance or specification if access to the PMU FIFO is blocking or not. The h_GetFIFO may also be called with a number of attributes of the PMU instance, such as defining a prefetch distance, which is a numeric value specifying how far ahead to prefetch cache lines.

The second function of the API may be an h_PushFIFO method, which takes as input a handle obtained from the h_GetFIFO call and an address. It may also take an address offset, depending on the low-level implementation. This method causes the PMU to store a new address to prefetch FIFO and if the entry is within the prefetch distance from the front to immediately issue a prefetch operation.

The third function of the API may be an h_FIFOLoad method, which performs a read operation on an address which is currently at the output of the FIFO. This read operation may be typed, and can return a result depending on the type used, with an option to advance the FIFO—effectively ensuring the next such read will be from the location specified by the next FIFO entry. The advancement of the FIFO may be optional, so that a program can choose to advance the FIFO or not. This permits a subsequent h_FIFOLoad operation to read the same memory location, thereby allowing the system to handle cases where the algorithm may read the same memory location more than once.

The final function of the API may be an h_ReleaseFIFO method, which releases the FIFO for use by another program.

This first program may be transformed into a third program, which uses the described API and a PMU such as PMU 210:

```
#define PFD 4
fifo_t pfh = h_GetFIFO(hash, (PFD << 1)| 1);
if (!pfh) {
  do_original_implementation( );
} else {
  for (i=0; i < PFD; i++) {
    h_PushFIFO(pfh, hash_function(A[i]));
  }
  for (i=0; i<N; i++) {
    // Access hash
    data = h_FIFOLoad(pfh);
    // Push next access to the FIFO
    if (i < N-PFD) {
      h_PushFIFO(pfh, hash_function(A[i+PFD]));
    // Perform data processing.
    process(data);
  }
}
h_ReleaseFIFO(pfh);
```

Notably, the code required for this API approach is similar to, but simpler than, a software-only approach. In this code, depending on the outcome of h_GetFIFO, the program may either implement the original code or may use optimized code which takes advantage of the features of the hardware PMU through its API. This optimized code may be closer to the original code of the loop, rather than the software-only approach, as the FIFO management code is implemented through API calls and executed by the hardware PMU.

The API-based PMU described herein may be more manageable when used with tools which can leverage this approach. For example, enhanced compilers may be used which may be configured to detect cases where the PMU may be beneficial and then modify a program accordingly. For example, such a compiler may take the code of the first program, identify that the PMU would improve the program, and generate a binary based on the third program including the associate API calls.

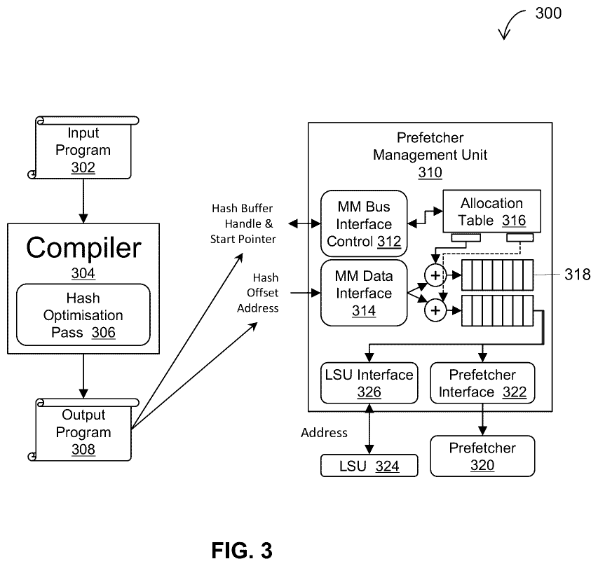

FIG. 3 is an illustration 300 of a compiler 304 and a prefetcher management unit 310, according to one aspect of the present disclosure. PMU 310 is generally similar to PMU 210, however having regard to PMU 310, the bus interface 312 may be configured to use a hash buffer handle and a starting pointer, while the data interface 314 may be configured to use a hash offset address instead of an absolute address as is in the case of PMU 210. The start pointer may represent a memory location of the first element in a hash, and the hash offset address may represent a distance from the first element to the desired element. For example, the allocation table 316 may include a base memory location of the first element in a hash, and each element of the FIFO 318 may include a memory offset to locate a particular piece of data. The PMU 310 may be configured to add the base memory location and the offset together, and to use these locations to drive the prefetcher interface 322 to instruct a prefetcher 320 to load the data into cache memory, and to use the base memory location and the offset to drive the LSU interface 326 to instruct the LSU 324 to load the data. This implementation may be more memory-efficient, as the FIFO 318 storage of memory offsets may require less memory than each element of the FIFO 318 storing a full memory location.

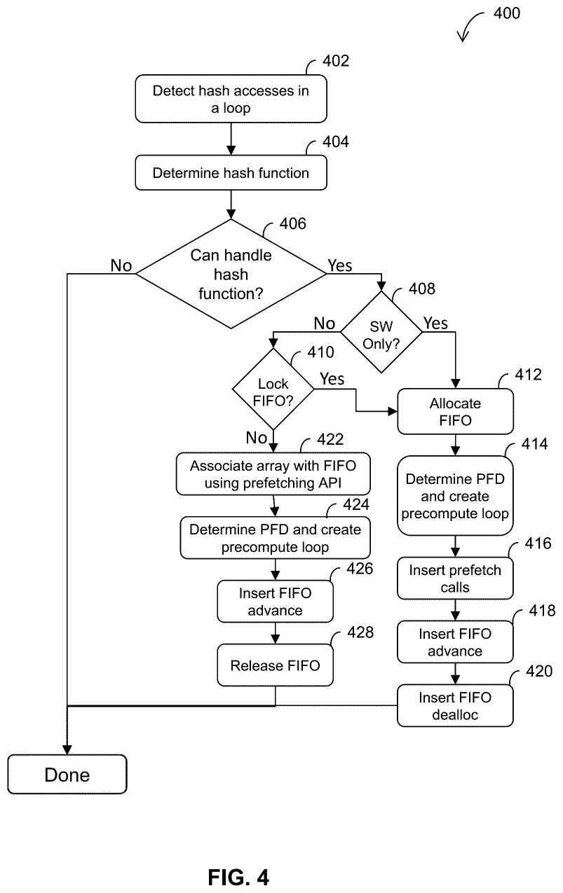

FIG. 4 is a flow chart 400 which illustrates how a compiler can perform code transformations to leverage hash prefetching hardware and API, according to one aspect of the present disclosure. Generally, similar logic may be used to allow a compiler to support hash prefetching with either a hardware and software co-design, or with a software-only design leveraging existing PMU APIs. The compiler may be configured to identify segments of code where hash-like accesses are performed often enough to warrant the use of a PMU to reduce cache misses and subsequently reduce runtime. Once it has identified these code segments, the compiler may be configured to transform code to create appropriate prefetching calls or leverage hardware designed to assist in prefetching of such indirect accesses.

At block 402, the compiler detects hash accesses which are in a loop. Generally, hash access in a loop may be necessary to ensure that there is a high enough frequency of accesses to pay for the cost of the optimization. Otherwise, if the hash accesses are too infrequent, the optimization may slow down execution more than the improved prefetching improves execution.

At block 404, the compiler then determines a hash function which is used for the hash access. The compiler may also look for other types of functions with the same relevant properties, and a hash function is merely used as an example of a type of function for the prefetching techniques described herein.

At block 406, the compiler determines whether or not it can handle the hash function. It is possible that the hash function may be of a form which cannot be handled. For example, the code may be unable to be duplicated, or the code may have side-effects which would result in functional error if accesses are pre-computed, such as using memory which is mapped to input/output devices. It may also be impossible to determine have to precompute hash values in advance without potential side effects. The compiler may be configured to identify code which it can handle and to leverage hash prefetching techniques with that code, but also to recognize code that it cannot handle and to compile that code normally. If the compiled cannot handle the hash function for any reason, the compiler will exit this code transformation algorithm and compile the code as usual without leveraging a PMU.

At block 408, the compiler determines whether to use a software-only technique, or whether to leverage hardware hash prefetching. This determination may be based, at least in part, on whether the code is being compiled for a processor which supports hardware hash prefetching. If a software-only technique is desired, the compiler proceeds to block 412. Otherwise, the compiler proceeds to block 410.

At block 410, the compiler inserts code to ask the PMU if there is an available FIFO to be used for hash prefetching. This leverages PMU APIs to retrieve a handle to the FIFO that can be used for the given hash table. The compiler can then generate two alternate code paths. The first code path occurs when at runtime the handle for a new FIFO is allocated for the hash table in question. This will cause the compiler to follow the code generation steps along the block 422 path. On the other hand, if at runtime the program receives a negative response from the PMU, it means that no FIFO is available. In such a case, the compiler can generate the software-only solution where the FIFO is managed by the program itself. In this scenario, the compiler generates the code by following the path along block 412.

If a software approach is being used, at block 412, the compiler includes code to allocate the FIFO. At block 414, the compiler determines a prefetch distance and creates a precompute loop. At block 416, the compiler inserts prefetch calls. At block 418, the compilers inserts code to advance the FIFO. At block 420, the compiler inserts code to de-allocate the FIFO and free memory. Collectively, in these blocks, the compiler may take code akin to the first program and may convert it into code akin to the second program, described above. This code may be configured to pre-load the cache memory for future hash accesses, and may be configured to use a FIFO to store hash accesses, so that each hash function only need to be called a single time. The compiler may then finish this process and proceed with compiling normally. After compiling, the program may be a binary that can be executed by a processor.

If PMU comprises including hardware support for hash access optimization is available, at block 422, the compiler associates an array with a FIFO using the prefetching API. Next, at block 424, the compiler determines a prefetch distance and creates a precompute loop. At block 426, the compiler inserts code to advance the FIFO with each loop iteration. At block 428, the compiler includes code to release the FIFO. Collectively, the compiler in blocks 422, 424, 426, 428 may take code akin to the first program above and convert it into code like that in the third program, described above. This code may use a hardware PMU and associated API calls to improve the performance of a hash function, or a similar function, which is included in a compatible loop in the program. The compiler may then finish this process and proceed with compiling normally. After compiling, the program may be a binary that can be executed by a processor and use a hardware PMU associated with that processor.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, personal digital assistant (PDA), or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present disclosure. For example, such an execution may correspond to a simulation of the logical operations as described herein. The software product may additionally or alternatively include a number of instructions that enable a computer device to execute operations for configuring or programming a digital logic apparatus in accordance with embodiments of the present disclosure.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations, or equivalents that fall within the scope of the present invention.

What is claimed is:

1. A method of prefetching array segments with pseudo-random access patterns, the method comprising:
storing one or more addresses in a data structure, each of the one or more addresses representing a memory location of data stored in an array segment;
prefetching data to a cache line using an address of the one or more addresses; and
driving input to a load-store unit (LSU) to load the prefetched data from the cache line using the address of the one or more addresses.

2. The method of claim 1, wherein storing one or more addresses comprises storing one or more hash access addresses.

3. The method of claim 1, wherein storing one or more addresses comprises storing one or more hash offset addresses which can be added to a base memory location to form a hash access address.

4. The method of claim 1, wherein prefetching data to a cache line using an address of the one or more addresses comprises instructing a prefetcher interface to use a prefetcher to prefetch data to a cache line using an address of the one or more addresses.

5. The method of claim 1, wherein prefetching data to a cache line using an address of the one or more addresses comprises prefetching data to be used in a loop prior to its use in the loop and wherein driving input to a LSU to load the prefetched data comprises driving input to the LSU to load the prefetched data when the prefetched data is used in the loop.

6. The method of claim 1, wherein storing one or more addresses in a data structure comprises storing a plurality of addresses in a first-in-first-out (FIFO) data structure.

7. The method of claim 1, further comprising releasing the data structure.

8. A prefetcher management unit (PMU), comprising:
an interface to interact with programs via an application programming interface (API);
one or more data structures configured to store a plurality of addresses, each of the plurality of addresses representing a memory location of data stored in an array segment;
a prefetcher interface configured to use an address in the one or more data structures to instruct a prefetcher to prefetch data into a cache; and
a load-store unit interface configured to use the address in the one or more data structures to instruct a load-store unit to load data from the cache.

9. The PMU of claim 8, wherein the interface comprises:
a control interface which is configured to return a handle associated with a function, configured to interact with programs via an API; and
a data interface which is configured to receive the handle and to cache and retrieve data stored in array segments associated with the function, configured to interact with programs via an API.

10. The PMU of claim 8, wherein the one or more data structures comprise one or more FIFO data structures.

11. The PMU of claim 8, wherein the plurality of addresses comprise a plurality of hash access addresses.

12. The PMU of claim 8, wherein each address of the plurality of addresses comprises a hash offset address which can be added to a base memory address to form a hash access address.

13. A method of compiling source code including a hash optimization pass, the method comprising:
receiving source code;
identifying portions of the source code which can be accelerated using a prefetcher management unit (PMU);
inserting calls to a PMU in the source code; and
compiling the source code to generate a binary.

14. The method of claim 13, wherein identifying portions of the source code which can be accelerated using a PMU comprises identifying portions of the source code which include accesses of data stored in an array segment in a loop.

15. The method of claim 13, wherein identifying portions of the source code which can be accelerated using a PMU comprises identifying portions of the source code which include hash accesses in a loop.

16. The method of claim 13, wherein inserting calls to a PMU in the source code comprises:
associating an array with a first-in-first-out (FIFO) using a prefetcher application programming interface (API);
determining a prefetching distance and creating a precompute loop;
inserting instructions into the source code to advance the FIFO; and
inserting instructions into the source code to release the FIFO.
